(19) United States
(12) Patent Application Publication
(10) Pub. No.: US 2019/0075381 A1
(43) Pub. Date: Mar. 7, 2019

(54) CEILING SPEAKER ASSEMBLY

(71) Applicant: Robert Katz, Montreal (CA)

(72) Inventor: Robert Katz, Montreal (CA)

(21) Appl. No.: 16/121,252

(22) Filed: Sep. 4, 2018

Related U.S. Application Data
(60) Provisional application No. 62/554,301, filed on Sep. 5, 2017.

(51) Int. Cl. H04R 1/02

(52) U.S. Cl. CPC H04R 1/026; H04R 2201/021

(57) ABSTRACT

A ceiling speaker assembly having a substantially planar sound board, an inertial type acoustic transducer fixed secured to the sound board, and, means for suspending the sound board from a structure.

### FIELD OF THE INVENTION

The present invention relates generally to speaker assemblies, more particularly to ceiling speaker assemblies, more particularly to ceiling speaker assemblies that include an inertial type acoustic transducer fixedly secured to a sound board, and, yet more particularly, to ceiling speaker assemblies suspended from a ceiling or other structure.

### BACKGROUND OF THE INVENTION

Bringing audio content to various environments has been the goal of audio equipment builders as well as builders of the environments and consultants specifying the equipment which propagate the audio signals in the environments. By way of example, some of these environments may include office buildings, warehouses, grocery stores, arena, gymnasiums, schools, big box department stores, or other private or public use buildings or spaces.

Some of these buildings have vaulted or plenum-type (open) ceilings, perhaps with exposed I-beams or other structure. It has been a problem and challenge to provide speaker assemblies for these types of building and structures that provide enhanced sound fidelity and uniform, sound distribution produced by aesthetically pleasing and unobtrusive speaker assemblies.

Rooms which have these types of ceilings vary widely in their purpose but often are intended for environments such as, but not limited to, warehouses, grocery stores, big box department stores, offices, hospitals, schools, auditoriums, arenas, gyms, fitness centers, and the like. What is common to these types of facilities is the need for the propagation of an audio signal which can fulfill functions such as general paging, emergency paging, background or foreground music, noise control by way of active noise reduction, sound masking or combinations of the same. Other uses can be envisioned by experts endeavoring in the field of sound reproduction.

Audio systems in many of the targeted environments would also benefit from a distributed audio network where each suspended ceiling speaker would act as a speaker on an audio network and where each speaker is an addressable node on the network. If networked, each speaker would be able to be fed a source signal from a conventional low impedance amplifier or a constant voltage amplifier which is typically a 70V or 100V audio system, and create targeted areas where dedicated source signals can be sent to. The networking system would allow large arrays of suspended (or pendant) speakers throughout a building or buildings using the network to act as a distributed audio system.

Acoustically energizing a suspended ceiling speaker as described herein would also allow the speaker system to act as a planar acoustic radiating surface using bending wave physics. The vibrational audio exciter would excite the speaker system as it is composed of at least one panel structure, such that bending waves cover its surface. Where these waves collide, full frequency sound is emitted. The resultant is even frequency response in the propagation pattern. As the panel is a planar emitter using bending wave physics, it exhibits a very wide polar propagation pattern. The listening experience is unlike that of a conventional cone type ceiling speaker having a limited conical shape propagation pattern where high frequency bandwidths are focused narrowly in the center axis of the cone. The ceiling speaker's propagation is very open and has been measured to cover angles normal to the surface being driven as well as lateral angles including 0° and 180° with full frequency response. A much larger spatial volume is covered as compared to conventional speakers. This would result in fewer speakers required to cover a volume of space.

Bending wave acoustic radiators are known to project sound deeper into space as the size of the speaker diaphragm is larger and the resulting acoustic near field is far deeper than a conventional cone speaker which rolls of logarithmically. This again helps reduce the number of speakers required to fill a volume of space with sound as compared to a cone type speaker.

Thus, there has been a long-felt need for an aesthetically pleasing, unobtrusive, enhanced fidelity acoustic radiator speaker assembly arranged to be suspended from a ceiling of a building or other structure.

### BRIEF SUMMARY OF THE INVENTION

The present invention broadly comprises a ceiling speaker assembly having a substantially planar sound board, an inertial type acoustic transducer fixed secured to the sound board, and, means for suspending the sound board from a structure.

A general object of the invention is to provide a ceiling speaker assembly arranged to be suspended from a ceiling or similar structure.

Another object of the invention is to provide a ceiling speaker assembly capable of producing uniform, enhanced fidelity sound distributed through a large open space.

A further object of the invention is to provide an aesthetically pleasing, unobtrusive ceiling speaker assembly, arranged to be suspended or hung from a ceiling or similar structure.

These and other objects, features and advantages of the present invention will become apparent upon a reading of the following detailed description, in view of the drawings and claims.

### BRIEF DESCRIPTION OF THE DRAWINGS

The invention is described in detail below with reference to the drawings, wherein:

FIG. 1 is a perspective view of the sound board/transducer/mounting bracket assembly of the present invention;

FIG. 2 is a bottom perspective view of the sound board/transducer/mounting bracket assembly shown in FIG. 1;

FIG. 3 is a top view of the sound board/transducer/mounting bracket assembly shown in FIG. 1;

FIG. 4 is a side view of the sound board/transducer/mounting bracket assembly shown in FIG. 3;

FIG. 5 is a bottom view of the sound board/transducer/mounting bracket assembly shown in FIG. 1;

FIG. 6 is a side view of the sound board/transducer/mounting bracket assembly shown in FIG. 1, except further showing one means for suspending the speaker assembly from a ceiling or similar structure;

FIG. 7 is a perspective view similar to that of FIG. 1, except showing a rectangular (square) sound board and a single cable suspension mechanism; and,

FIG. 8 is a perspective view similar to that of FIG. 7, except showing a dual cable suspension mechanism.

### DETAILED DESCRIPTION OF THE INVENTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

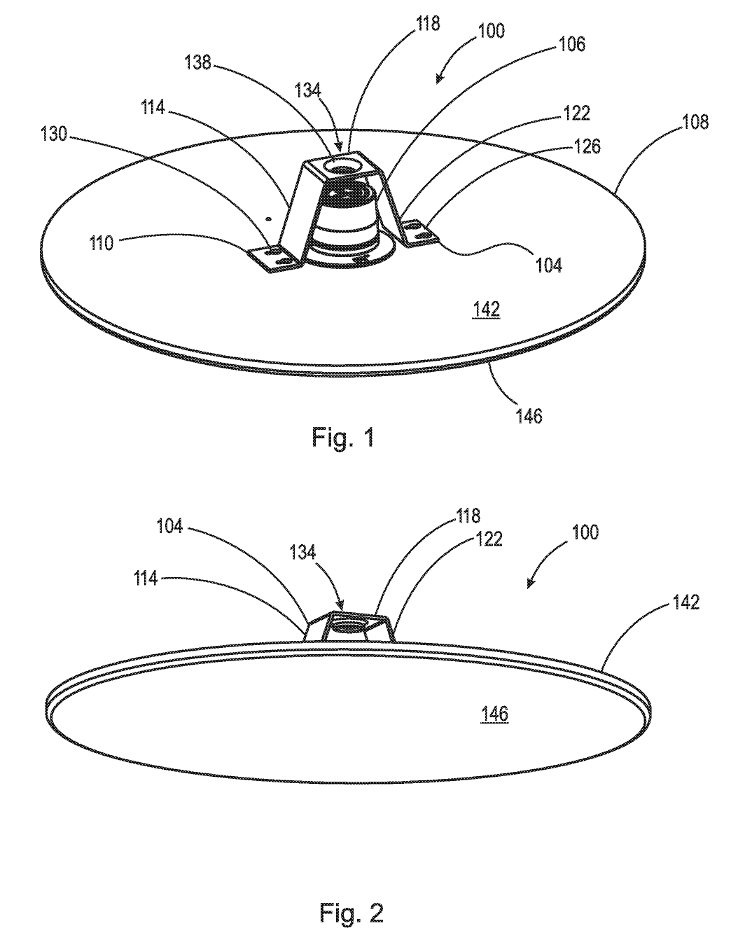

FIG. 1 is a perspective view of the sound board/transducer/mounting bracket assembly of the present invention. The assembly is seen to broadly comprise vibrational audio exciter 106 which is fixedly secured to sound board 108. The audio exciter is of a type disclosed in U.S. Pat. No. 8,724,844, which patent is incorporated herein by reference. Bending wave physics exhibited in sound board 108 are the result of the mechanical excitation of vibrational audio exciter 106. Bending wave physics are commonly known by those skilled in the art and will not be described herein other than stating consistent full frequency response is measured 360° around the sound board and no high frequency beaming is exhibited as is with cone shaped speaker architectures. Acoustic dispersion patterns are essentially omnidirectional creating even sound pressure level around the speaker assembly can be attained covering larger amounts of space within the room where the suspended speaker assembly is installed. This results in better dispersion for general purpose audio applications such as music paging and sound masking. The vibrational audio exciter may be secured to the sound board either mechanically or adhesively.

Sound board 108 may be made of one of several materials which ideally exhibit a high stiffness to weight ratio. For example, the sound board may be made of material selected from the group of medium density fiberboard, foamed PVC, metal, wood, and fiberglass (or a fiberglass composition). This provides acoustic sensitivity and a higher amount of sound pressure to be produced per watt of power input into the vibrational audio exciter 106. Due to the linear degradation of sound pressure over distance generated by the sound board element, outdoor and large building spaces all benefit from the even sound field produced as well as the ability to send sound effectively (near field characteristics). The sound board element may also be made of a polymeric material that is resistant to ultraviolet degradation.

A wire 102 sends the source signal to the vibrational audio exciter 106. Each speaker can be an addressable node on an audio network so as to allow the suspended speaker to function to its full potential in the varied environments is can be installed into as previously described. The environments can include but are not limited to a local area such as an office, a big box store, a grocery store, a warehouse, a gymnasium, a school, a hospital, a floor in an office building, multiple floors, and multiple buildings forming a campus. The sound signal would be delivered via wire 102 from an amplifier as is well known in the art. For example, the amplifiers used in a networked system of suspended speakers may be either low impedance 8Ω amplifiers or 70 volt or 100 volt constant voltage audio amplifiers which are commonly used for larger speaker deployments.

Bracket 104 is fixedly secured to sound board 108. In a preferred embodiment, the bracket is secured atop top surface 142 of the sound board using screws that pass through mounting holes 130. The purpose of the bracket is to provide a means for suspending the speaker assembly from a ceiling, I-beam, or other similar structure. The interface between bracket 104 and sound board 108 may utilize a dampening substrate such as a thin visoelastomeric sheet to avoid any dissonant vibration. Although the bracket shown in the drawings is shown to form an isosceles trapezoid with the sound board, it should be appreciated that the bracket can take many shapes and forms, such as a rectangle, or flanged open bottom cylinder for example. Bracket 104 is seen to include first mounting flange 110 and second mounting flange 126. Both flanges include holes 130, through which mounting screws (not shown) pass to secure the bracket to the sound board. The mounting bracket comprises the first and second mounting flanges, first angled mounting bracket 114, second angled mounting bracket 122, and top bracket member 118. In a preferred embodiment, top bracket member 118 includes threaded aperture 134 having internal threads 138. The threaded aperture is arranged to receive a means of suspending the assembly, such as by threaded engagement with a conduit.

FIG. 2 is a bottom perspective view of the sound board/transducer/mounting bracket assembly shown in FIG. 1. It should be appreciated that a person looking upward toward the speaker assembly will only see bottom surface 146 of the sound board. The assembly will appear as a flat round surface (or as a polygonal surface in some embodiments) and it is unlikely that the person would even realize or appreciate that the structure is, in fact, a speaker. This unobtrusive, aesthetically pleasing appearance of the speaker is one of the objects of the invention.

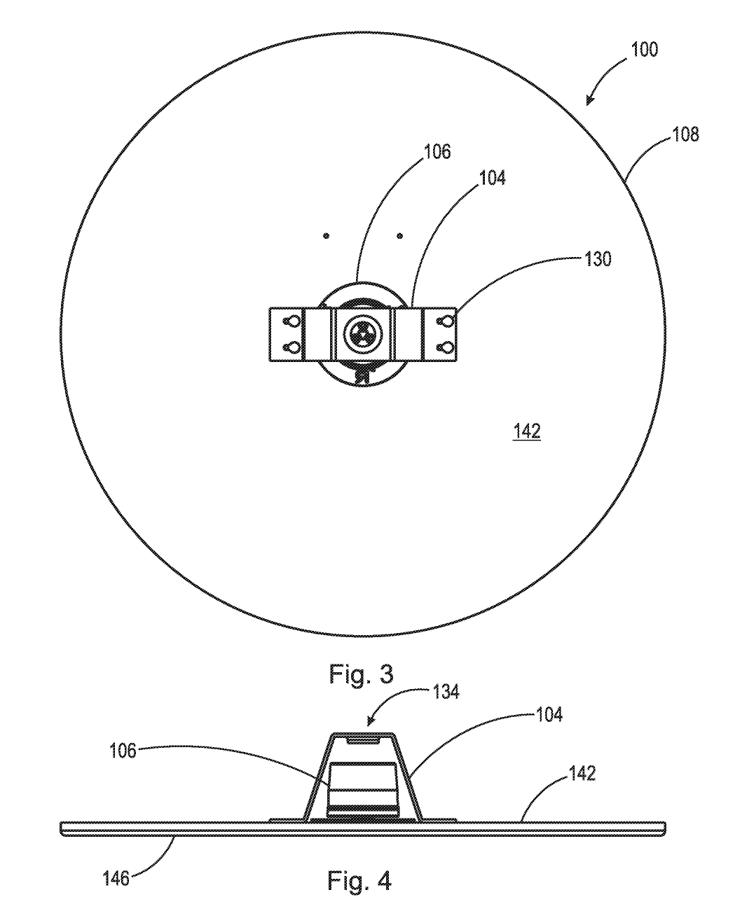

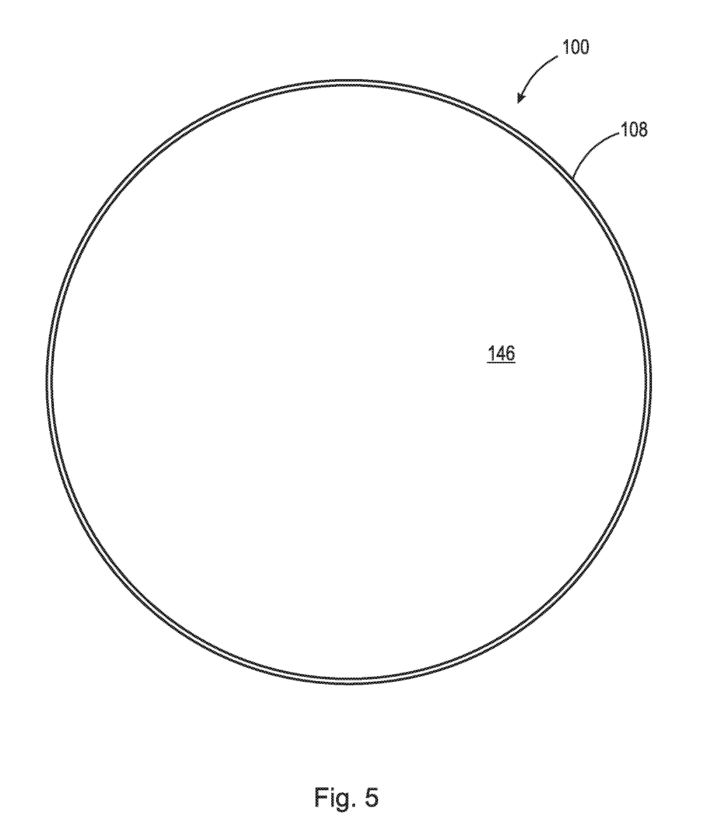

FIG. 3 is a top view of the sound board/transducer/mounting bracket assembly shown in FIG. 1. FIG. 4 is a side view of the sound board/transducer/mounting bracket assembly shown in FIG. 3. FIG. 5 is a bottom view of the sound board/transducer/mounting bracket assembly shown in FIG. 1.

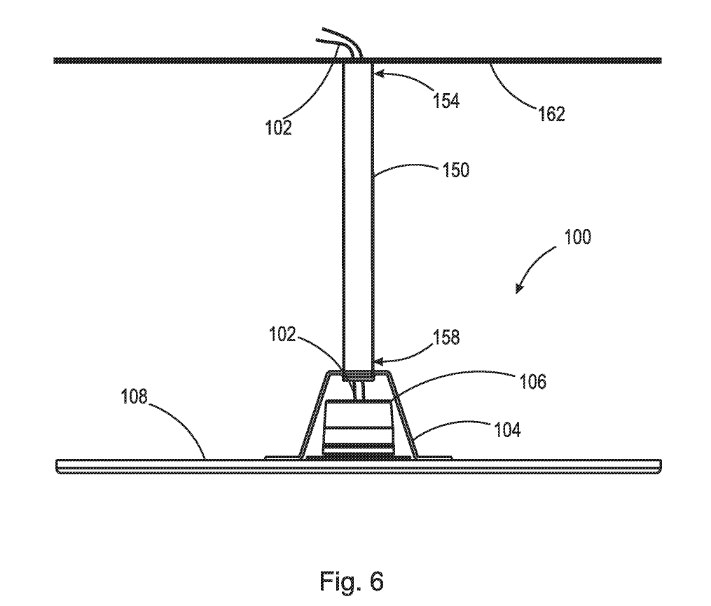

FIG. 6 is a side view of the sound board/transducer/mounting bracket assembly shown in FIG. 1, except further showing one means for suspending the speaker assembly from a ceiling or similar structure. In the embodiment shown, the means for suspending the speaker assembly from ceiling 162 is a conduit, namely conduit 150 having a first threaded end 158 that threadably engages bracket 104, and a second threaded end 154 which threadably engages a similar bracket (not shown) in ceiling 162 or an electrical junction box or other common means. In a preferred embodiment, conduit 150 is a hollow metal tube, and speaker wires 102 are routed to the acoustic exciter inside the tube. It should be appreciated, however, that the means for suspending the speaker assembly may take other forms. For example, the means may comprise a single cable (not shown) secured both to the ceiling or other structure and to bracket 104. Since a single cable may permit swaying or rotation of the assembly, the means may comprise a plurality of cables secured to the ceiling or other structure on one end, and to bracket 104 on the other end. Note that, in a preferred embodiment, the suspension means is secured to the bracket, and not to the sound board itself to preserve audio fidelity but may in certain circumstances be affixed to the sound board.

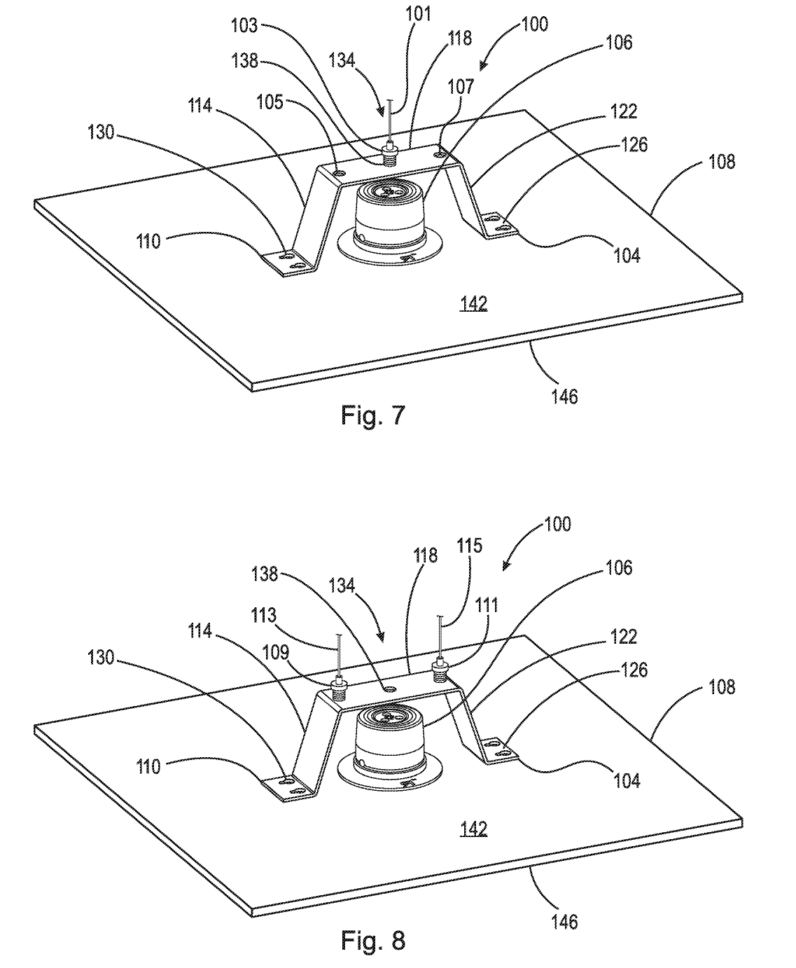

FIG. 7 is a perspective view of the sound board/transducer/mounting bracket assembly shown in FIG. 1, except that sound board 108 that is rectangular and further shows another means for suspending the speaker assembly from a ceiling or similar structure. In the embodiment shown, the means for suspending the speaker assembly is a single wire, namely wire 101 is removably secured to bracket 104 by cable suspension mechanism 103, which threadably engages with bracket 104 at threaded aperture 134. Threaded aperture 134 is operatively arranged in the center of bracket top surface 118.

FIG. 8 is a perspective view of the sound board/transducer/mounting bracket assembly 100 shown in FIG. 7, except further showing another means for suspending the speaker assembly from a ceiling or similar structure. In the embodiment shown, the means for suspending the speaker assembly is two wires, namely a first wire 113 and a second wire 115, each removably secured to bracket 104 by cable suspension mechanisms 109, 111 which threadably engages with bracket 104 at threaded apertures 105, 107. Apertures 105, 107 are operatively arranged at opposite ends of the bracket top surface 118 to minimize rotation.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. For example, although the invention is described as a ceiling speaker assembly, and is arranged to be suspended from a ceiling, it obviously could be suspended from any similar structure, such as an I-beam, cantilever arm, wood plank, metal rod, or the like. Therefore, other embodiments of the present invention are possible without departing from the spirit and scope of the claims. For example, as sound is propagated in an omnidirectional fashion, the sound board could even be oriented in a vertical orientation, mounted to a wall surface as a sconce. In this embodiment, the sound board would be mounted to the wall surface by securing bracket 104 directly to a wall with dry wall screws, anchors, and the like. For example, one might mount a pair of “sound board sconces” on either side of a large window for stereo effect.

### REFERENCE NUMBERS

100 Ceiling speaker assembly
102 Wires
104 Bracket
106 Transducer (vibrational audio exciter)
108 Sound board
110 First mounting flange
114 First angled bracket member
118 Top bracket member
122 Second angled bracket member
126 Second mounting flange
130 Mounting holes
134 Threaded aperture
138 Threads
142 Top surface of sound board
146 Bottom surface of sound board
150 Conduit
154 First end of conduit
158 Second end of conduit
162 Ceiling

What is claimed is:

1. A ceiling speaker assembly, comprising:
a substantially planar sound board;
an inertial type acoustic transducer fixedly secured to said sound board; and,
means for suspending said sound board from a structure.

2. The ceiling speaker assembly recited in claim 1 wherein said means for suspending said sound board from a structure comprises a conduit.

3. The ceiling speaker assembly recited in claim 2 wherein said conduit is a metal tube.

4. The ceiling speaker assembly recited in claim 1 wherein said means for suspending said sound board from a structure comprises at least one cable.

5. The ceiling speaker assembly recited in claim 1 wherein said means for suspending said sound board from a structure comprises at least two cables.

6. The ceiling speaker assembly recited in claim 1 wherein said sound board is round.

7. The ceiling speaker assembly recited in claim 1 wherein said sound board is in the shape of a polygon.

8. The ceiling speaker assembly recited in claim 1 wherein said sound board is in the shape of a square.

9. The ceiling speaker assembly recited in claim 1 wherein said sound board is made of a material selected from the group consisting of medium density fiberboard, foamed PVC, metal, wood, and fiberglass.

10. The ceiling speaker assembly recited in claim 1 wherein said sound board is made of aluminum.

11. A wall speaker assembly, comprising:
a substantially planar sound board;
an inertial type acoustic transducer fixedly secured to said sound board; and,
means for attaching said sound board to a structure.

12. The wall speaker assembly recited in claim 11 wherein said means for attaching is drywall screws.

13. The wall speaker assembly recited in claim 11 wherein said means for attaching is drywall anchors.
